(19) United States
(12) Patent Application Publication
(10) Pub. No.: US 2010/0133239 A1
(43) Pub. Date: Jun. 3, 2010

(54) Submerged Arc Narrow Gap Welding With Oscillating Electrode

(76) Inventor: Karl-Heinz Gunzelmann, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/990,133

(22) PCT Filed: Jun. 22, 2006
(86) PCT No.: PCT/EP2006/063460

§ 371 Date: Feb. 7, 2008

(30) Foreign Application Priority Data
Aug. 8, 2005 (DE) 10 2005 037 360.7

(51) Int. Cl. B23K 9/18

(52) U.S. Cl. 219/73

(57) ABSTRACT

There is described a method for submerged-arc narrow-gap welding, in which the wire electrode is set in oscillating motion in the gap in order to produce a first bead, the arc moving backwards and forwards between one of the workpiece edges and a middle section of the gap so that the first bead does not extend from the first to the second workpiece edge.

### CROSS REFERENCE TO RELATED APPLICATIONS

This application is the U.S. National Stage of International Application No. PCT/EP2006/063460, filed Jun. 22, 2006 and claims the benefit thereof. The International Application claims the benefits of German application No. 10 2005 037 360.7 DE filed Aug. 8, 2005, both of the applications are incorporated by reference herein in their entirety.

### FIELD OF INVENTION

The present invention relates to a submerged arc narrow gap welding method for joining metallic workpieces.

### BACKGROUND OF INVENTION

In addition to TIG and MIG/MAG narrow gap welding, submerged arc narrow gap welding is also used for welding thick-walled components. MAG welding is described in DE 196 26 631 C1. Here the welding device is traversed in the weld groove while at least one consumable wire electrode guided through a contact tube is supplied to the weld area under shielding gas at a predefined wire feed rate. To ensure good weld seam quality, the arc struck between wire electrode and workpiece is moved alternately to the two workpiece sidewalls by a rotating movement of the end of the wire electrode, the position of the arc being monitored by sensors which detect its movement.

The precise positioning of the wire electrode in the various welding methods is often controlled by using leading feelers 7, e.g. arranged in combination with photodiodes 8, on the workpiece sidewalls and weld root. Other welding methods use preceding continuous image analysis of the seam geometry for deriving correction movements of the wire electrode. For MIG/MAG welding and pulsed current TIG welding, EP-A-0 186 041 A1 proposes using the arc as a sensor for automatic correction of the welding apparatus. For this purpose the oscillating movement of the wire electrode about the center of the gap together with the measured welding current and/or welding voltage are evaluated.

### SUMMARY OF INVENTION

Submerged arc narrow gap welding is primarily used where high burn-off rates can be realized. It is also used where the requirements in terms of workpiece properties such as toughness and hardness can be best achieved and ensured thereby. To achieve sidewall fusion, submerged arc narrow gap welding uses angled wire feeding at the end of the electrode, as shown in FIG. 1. With the electrode end 6 fixedly positioned in this way, two to three beads 1 to 5 are disposed adjacent to one another to form a layer in the gap 10 of the workpiece 9. The widths of the gap 10 range between 18 and 22 mm, or possibly more. Precise matching of the end of the wire electrode to the torch height and side clearance is indispensable for ensuring reliable layer build-up using the beads 1 to 5.

For submerged arc narrow gap welding of thick-walled workpieces, the lateral penetration quality depends on the precise orientation of the wire electrode to the workpiece sidewall. Incorrect orientation which cannot be visually detected through the powder covering typically results in sidewall fusion defects. This occurs when the welding torch moves obliquely to the workpiece sidewall. A relatively large gap width is also required because of the torch and the wire electrode diameter usually employed.

An object of the present invention is therefore to provide a more reliable submerged arc narrow gap welding method compared to the prior art.

This object is achieved by a submerged arc narrow gap welding method as claimed in an independent claim. Advantageous embodiments of said welding method will emerge from the description below, the drawings and further claims.

The method according to the invention is carried out using a welding device which can be traversed within a gap between a first and a second workpiece sidewall and which has a movable wire electrode for selectively positioning an arc. The arc is struck at the end of the wire electrode by presetting a welding voltage and/or a welding current. To produce a first bead inside the gap, the wire electrode is then moved in an oscillating motion causing the arc to be moved back and forth between one of the workpiece sidewalls and a central region of the gap so that the first bead does not extend from the first to the second workpiece sidewall.

In order to produce beads of high durability and good connection to the workpiece sidewalls, in its method for submerged arc narrow gap welding the present invention uses an oscillating movement of the wire electrode. The oscillating movement preferably extends between a first workpiece sidewall and a central region of the gap. This prevents the slag layer forming on the bead during cooling from being braced between the two opposing workpiece sidewalls, thereby facilitating removal of the slag layer from the deposited bead.

After removal of the slag layer from the first bead, the subsequent bead is disposed adjacent thereto within the gap and in connection to the second workpiece sidewall. The good connection to the workpiece sidewalls and the quality of the second bead is ensured by its being produced with the aid of the oscillating movement of the wire electrode between the other workpiece sidewall and the central region of the gap.

According to a preferred embodiment of the present invention, the arc is used as a sensor to determine the position of the arc in relation to the first and second workpiece sidewall. This is done by measuring the welding voltage actually present on the wire electrode and/or the welding current actually flowing in addition to the preset welding voltage and/or welding current and determining from this data the position of the arc. Using this data and the information derived therefrom, the oscillating movement of the wire electrode is corrected on the basis of the detected position of the arc.

### BRIEF DESCRIPTION OF THE DRAWINGS

Preferred embodiments of the present invention will now be described with reference to the accompanying drawings in which:

FIG. 1 shows prior art welding methods in which the beads of a layer are produced using a fixed deflection wire electrode,

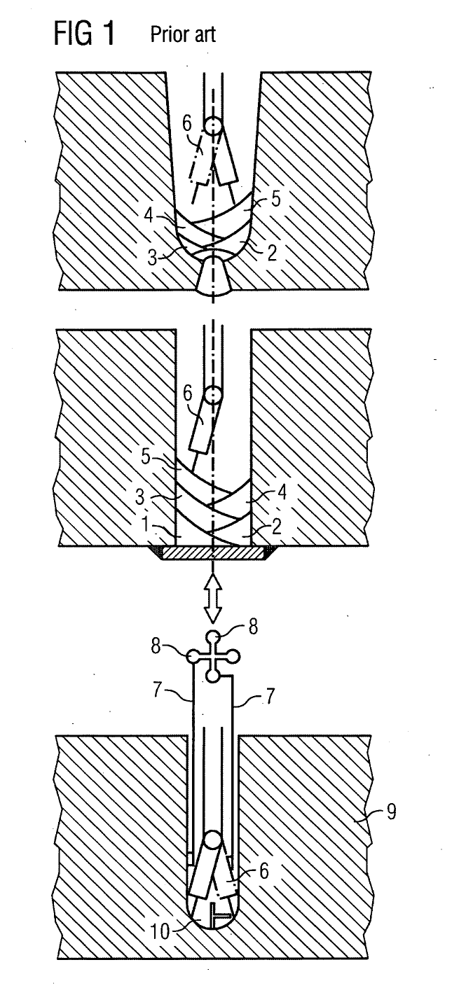

FIG. 2 schematically illustrates the welding device for carrying out the submerged arc narrow gap welding method.

### DETAILED DESCRIPTION OF INVENTION

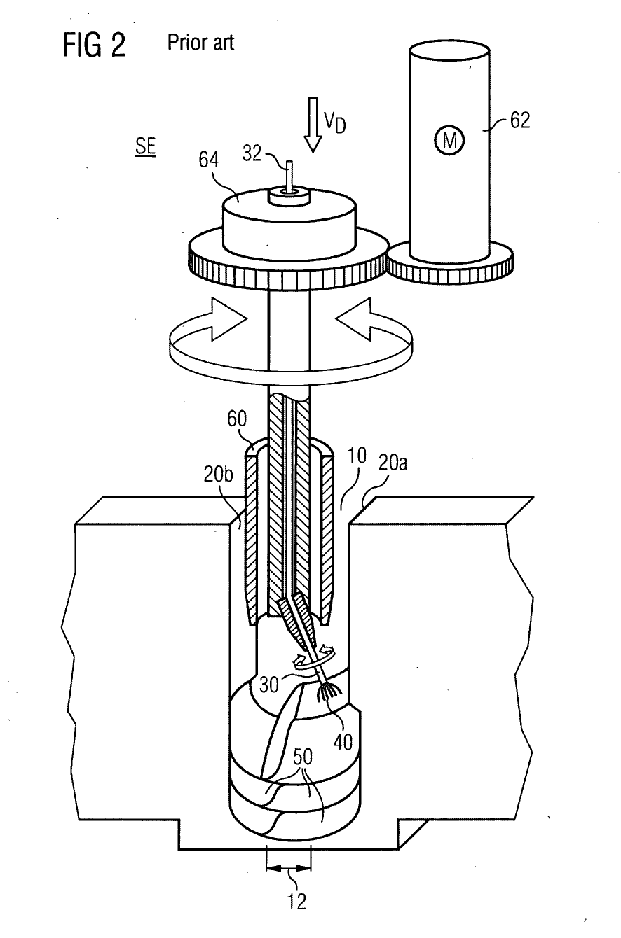

The submerged arc narrow gap welding method is preferably carried out by a welding device SE, as shown schematically in FIG. 2. With the aid of said welding method, opposing workpieces are joined along their workpiece sidewalls 20a, 20b using a weld seam. The welding device SE comprises a wire electrode 30 which is fed to the welding position via a contact tube 60. The wire electrode 30 is fed to the welding position via a feeding mechanism 32 with a speed V_{D}. The contact tube 60 with the wire electrode 30 is connected to a motor 62 via a gear 64. By revolving in alternating directions, the motor 62 produces a oscillating movement of the wire electrode 30 inside the gap 10, the amplitude of which can be adjusted. The welding device SE is positioned and moved inside the gap 10 in relation to the workpiece sidewalls 20a, 20b visible from above, while the motor 62 produces the oscillating movement with required amplitude of the wire electrode 30 inside the gap 10.

The arc 40 of the welding device SE is adjusted via the parameters welding current, welding voltage, electrode wire feed rate and distance between the top bead 50, i.e. the last welding layer, and the contact tube 60. Said arc 40 can be configured using its parameters both as a fixed or as a rotating arc 40.

In order to produce an optimum weld with long service life, the wire electrode 30 and the arc 40 execute an oscillating movement generated via the motor 62 between one of the workpiece sidewalls 20a, 20b and a central region 12 of the gap 10 and simultaneously move along the gap 10. In this way a first bead 50 is produced which is directly adjacent to one of the workpiece sidewalls 20a, 20b and extends approximately to the center of the gap 10 (cf. FIG. 2).

The first bead 50 only partially fills the gap 10 so that a complete layer is formed from at least two adjacently disposed beads 50. To form a layer, the number of beads 50 can be selected e.g. as a function of the width of the gap 10 or of the time available for the welding process.

When the first bead 50 has been formed between one of the workpiece sidewalls 20a, 20b and the central region 12 of the gap, the slag deposit (not shown) on the bead 50 is removed after the powder of the submerged arc narrow gap welding method has been e.g. sucked out of the gap 10. Forming the bead 50 between only one workpiece sidewall 20a and the central region 12 of the gap 10 prevents the slag deposit from being braced between the opposing workpiece sidewalls 20a and 20b which would make the slag more difficult or even impossible to remove. By means of the above-described oscillating movement, a bead 50 is therefore produced which, on the one hand, possesses optimum quality and, on the other, has slag deposited and hardening thereon which can be easily removed. In addition, the width of the bead 50 can be selectively adapted to the width of the gap 10. In order to further reduce the width of the gap 10, e.g. thinner wire electrode diameters can be used in the context of the submerged arc narrow gap welding method.

With submerged arc narrow gap welding, the position of the bead 50 in relation to the workpiece sidewalls 20a, 20b cannot be visually inspected during the welding process. The above method is therefore carried out while the welding device SE is positioned in relation to the workpiece sidewalls 20a, 20b which are visible from above and is moved along the gap 10. The oscillating motion enables the width of the oscillation and the orientation of the end of the wire electrode to the workpiece sidewall 20a, 20b to be continuously adjusted via motor control.

According to another embodiment of the present invention, with the submerged arc narrow gap welding method it is particularly advantageous to use the arc 40 as a sensor for detecting the position of the arc 40 in relation to the workpiece sidewalls 20a, 20b and to the already produced bead 50 or a complete layer. In conjunction with the arc 40 and its parameters as a sensor, it is therefore also possible with the submerged arc narrow gap welding method to provide automatic correction of the welding device SE in relation to the workpiece sidewall as in the open welding methods (TIG, MIG/MAG) without visual observation and intervention possibilities. For this purpose the arc configuration is first predefined by selecting welding voltage and/or welding current. During the welding process, the actual welding voltage and/or the actual welding current on the wire electrode 30 are detected and analyzed. The analysis of this data supplies the position of the arc 40 in relation to the adjacent workpiece sidewalls 20a, 20b and to the underside of the gap 10 which is formed by a complete layer or a bead 50. After eliminating interference such as noise from the acquired data, it can be seen that the welding voltage/welding current characteristic of the arc 40 reacts sensitively to the distance between wire electrodes 30 and workpiece. In this way the position of the arc 40 can be monitored on the basis of the actual welding data acquired.

The actual position of the arc 40 detected from the welding data of the arc 40 is transmitted to the control unit of the welding device SE in order—if necessary—to correct the movement of the welding device SE along the gap and/or the oscillating movement of the wire electrode 30 on the basis of the stored presets for the welding operation. On the basis of this method it is possible to carry out precise submerged arc narrow gap welding without visual contact with the bead 50 produced. In addition, there is no impairment of the weld seam by the slag deposit forming on the respective bead 50, as this deposit can be easily removed. If preferably a wire electrode 30 with a diameter of 1.2 mm is used, a submerged arc narrow gap seam of approximately 12 mm gap width can be achieved and reliably welded.

1.-5. (canceled)

6. A method for submerged arc narrow gap welding, comprising:
providing a welding device which can be traversed within a gap between a first and a second workpiece sidewall and has a movable wire electrode for selectively positioning an arc;
striking the arc at the end of the wire electrode;
providing an oscillating movement of the wire electrode inside the gap to produce a bead, wherein the arc moves back and forth between one of the workpiece sidewalls and a central region of the gap, wherein the bead does not extend from the first to the second workpiece sidewall.

7. The method as claimed in claim 6, wherein the gap widths is between 18 mm and 22 mm.

8. The method as claimed in claim 6, wherein the arc is controlled based upon a preset of a welding voltage.

9. The method as claimed in claim 6, wherein the arc is controlled based upon a preset of a welding current.

10. The method as claimed in claim 6, wherein the arc is controlled based upon a preset of a welding voltage and a preset of a welding current.

11. The method as claimed in claim 6, further comprising:
removing a slag from the bead prior to production of a further bead.

12. The method as claimed in claim 6, further comprising:
producing a further bead in a lateral connection to the previous bead based upon an oscillating movement of the wire electrode between the second of the workpiece sidewalls and the central region of the gap.

13. The method as claimed in claim 11, further comprising:
producing a further bead in a lateral connection to the bead based upon an oscillating movement of the wire electrode between the second of the workpiece sidewalls and the central region of the gap.

14. The method as claimed in claim 6, further comprising:
using the arc as a sensor, and
determining the position of the arc in relation to the first and second workpiece sidewall based upon the sensor.

15. The method as claimed in claim 12, further comprising:
using the arc as a sensor, and
determining the position of the arc in relation to the first and second workpiece sidewall based upon the sensor.

16. The method as claimed in claim 13, further comprising:
using the arc as a sensor, and
determining the position of the arc in relation to the first and second workpiece sidewall based upon the sensor.

17. The method as claimed in claim 14, further comprising:
detecting an actual welding voltage, and
determining the position of the arc based upon the actual welding voltage.

18. The method as claimed in claim 14, further comprising:
detecting an actual welding current, and
determining the position of the arc based upon the actual welding current.

19. The method as claimed in claim 14, further comprising:
detecting an actual welding voltage,
detecting an actual welding current, and
determining the position of the arc based upon the actual welding voltage and current.

20. The method as claimed in claim 17, further comprising:
correcting the oscillating movement of the wire electrode based upon the determined position of the arc.

21. The method as claimed in claim 18, further comprising:
correcting the oscillating movement of the wire electrode based upon the determined position of the arc.

22. The method as claimed in claim 19, further comprising:
correcting the oscillating movement of the wire electrode based upon the determined position of the arc.

23. The method as claimed in claim 6, wherein a wire electrode is used having a diameter of 1.2 mm.

24. The method as claimed in claim 23, wherein a width of the submerged arc narrow gap seam is essentially 12 mm.
